(19) United States
(12) Patent Application Publication
(10) Pub. No.: US 2008/0197317 A1
(43) Pub. Date: Aug. 21, 2008

(54) Working Fluid For Heat Transfer

(75) Inventor: Martin Schwiegel, Koln (DE)

Correspondence Address: CONNOLLY BOVE LODGE & HUTZ, LLP, P O BOX 2207, WILMINGTON, DE, 19899, US

(73) Assignee: Solvay Fluor GmbH, Hannover (DE)

(21) Appl. No.: 11/666,771

(22) PCT Filed: Oct. 20, 2005
(86) PCT No.: PCT/EP2005/011266

§ 371 Date: Oct. 30, 2007

(30) Foreign Application Priority Data
Nov. 4, 2004 (EP) 04026210.7

(51) Int. Cl. C09K 5/04

(52) U.S. Cl. 252/67

(57) ABSTRACT

Working fluid for the heat transfer, in particular for the heat transfer by heat pipes, containing or consisting of partially fluorinated and/or perfluorinated hydrocarbons and/or perfluorinated polyethers. Preferably, a mixture of pentafluorobutane and perfluorinated polyether is used as a working fluid.

The invention relates to a working fluid for the heat transfer, in particular, a working fluid for heat pipes.

By a heat pipe, a device is meant which conveys heat chiefly in one direction and utilizes the heat of evaporation of a liquid for the heat transfer. The liquid is evaporated at the hot end of the heat pipe and condensed again at the colder end. A heat pipe is usually formed by a hermetically closed pipe which contains a small quantity of a low-boiling liquid, i.e. the working fluid. The lower zone of the pipe is get in contact with the excessive heat zone, for example, with the component to be cooled and thus the lower zone is heated. By this, the liquid in the pipe evaporates and the vapour rises up to the upper zone of pipe, while heat is removed from it, the liquid is condensed and, due to the force of gravity, returned to the lower zone of pipe.

The heat pipe can be arranged both horizontally and vertically. Inclined heat pipes are also known. The kind of installation or the arrangement of the heat pipes depends on each application. Thus, depending on each kind of pipe arrangement, the condensate can be returned both—so far as there is an incline—by the force of gravity or—if there is no incline—by capillary forces without the effect of the force of gravity. In order to improve the reflux of the working fluid, porous layers such as sintered metal layers or microstructures at the internal wall of pipe are usually arranged.

The use of heat pipes is not limited to certain applications. Recent developments have shown that, thanks to the minimization of the heat pipe size, the heat pipes can be increasingly used also in the electronics industry.

As known, the cooling effect for electronic components can be achieved in different manner. The simplest cooling method is to use fans which are installed in switch cabinets. In order to support the heat transfer, heat sinks with large ribbed surfaces—if reasonable, with integrated fans—are often used. For cooling the components in the power electronics, it is necessary to use solid heat sinks made of copper or aluminium which may have a wall thickness of up to 30 mm. A consequence is that the units have a high weight and a great construction volume which is a significant disadvantage for the equipment design. Due to the limited cooling effect of such solid heat sinks, great flows of dissipated heat result in a distinct increase of the component's temperatures which, in turn, causes increased failure rates and worse efficiencies of the components.

Water recirculation cooling systems, in which water flows through a heat sink provided on the processor, are also known. Here the water is conveyed and recirculated by a pump and gives off its collected heat to the environment, e.g. via an air-cooled heat exchanger.

The heat removal by phase changing processes such as evaporative cooling and vaporization cooling is also known. Using this methods, a maximum heat removal per unit area can be achieved and thus the space needed for the component arrangement can be significantly reduced.

The design of the cooling facilities depends decisively on the kind of evaporation, i.e. nucleate boiling or convection boiling-, the pressure and temperature range and the heat transfer fluid used.

The problem of the invention is to ensure the heat removal of temperature-sensitive components by means of a phase changing process by using heat pipes which run with efficient working fluids as heat transfer fluids.

This object is preferably attained in a heat pipe in which partially fluorinated and/or perfluorinated hydrocarbons and/or polyethers and/or partially fluorinated or perfluorinated polyethers are used as working fluids or heat transfer fluids.

Suitable partially fluorinated and/or perfluorinated hydrocarbons include e.g. fluorinated alkanes from the group of pentafluoropropane such as 1,1,1,3,3-pentafluoropropane (HFC 245fa), 1,1,1,2,3-pentafluoropropane (HFC 245eb), 1,1,2,2,3-pentafluoropropane (HFC 245ca), hexafluoropropane such as 1,1,1,3,3,3-hexafluoropropane (HFC 236fa), 1,1,2,3,3,3-hexafluoropropane (HFC 236ea), 1,1,2,2,3,3-hexafluoropropane (HFC 236ca), heptafluoropropane such as 1,1,1,2,3,3,3-heptafluoropropane (HFC 227ea), pentafluorobutane such as 1,1,1,3,3-pentafluorobutane (HFC 365mfc), hexafluorobutane such as 1,1,1,2,2,4-hexafluorobutane (HFC 356mcf), heptafluorobutane such as 1,1,1,2,2,4,4-heptafluorobutane or decafluoropentane such as 1,1,1,2,3,4,4,5,5,5-decafluoropentane (HFC 43-10mee) as individual compound or mixture among one another.

In accordance with the invention, the partially fluorinated or perfluorinated hydrocarbons can be used also in a mixture with polyethers or partially fluorinated or perfluorinated polyethers as working fluids.

Suitable perfluorinated polyethers are described e.g. in the WO 02/38718. These perfluorinated polyethers contain carbon, fluorine and oxygen, have at least two, preferably three C—O—C ether bonds and have a molecular weight of approx. 200 or more and a boiling point above 40° C. at 101.3 kPa. Due to the production conditions, these ethers are a mixture of individual substances and have a viscosity of 0.3 to 1 cSt at 25° C.

Preferred perfluorinated polyethers include the products sold by Solvay Solexis under the names GALDEN and FOMBLIN. For example, the following products should be mentioned:
GALDEN HT 55: Boiling point: 57° C. at 101.3 kPa, molecular weight: 340
GALDEN HT 70: Boiling point: 66° C. at 101.3 kPa, molecular weight: 410
FOMBLIN PFS1: Boiling point: 90° C. at 101.3 kPa, molecular weight: 460

In an embodiment the individual substances HFC 365 mfc and GALDEN HT 55 were chosen from the said numerous compounds and used as a working fluid.

In another embodiment of the invention a mixture of 1,1,1,3,3-pentafluorobutane (HFC 365 mfc) and perfluorinated polyether (GALDEN HT 55) in a mixing ratio of 65:35 was used as a heat transfer fluid.

The quantity of the fluid used depends on the size of the cooling system.

For the purpose of invention, compounds are preferably suitable as efficient heat transfer fluids which are hardly flammable or inflammable and have an optimized surface tension and a high enthalpy of evaporation. The enthalpy value of the fluid should be large enough to obtain a maximum yield of heat transfer with small quantities of fluid. The compounds should have a high electrical resistance and a high dielectric strength. In particular for the use to cool electronic components, the fluids should have a vapour pressure around 1 bar at room temperature and not exceed the normal pressure after they have achieved their working temperature; in addition, the fluids should be liquid at ambient pressure and ambient temperature. The fluids should not be toxic, should have a low global warming potential (GWP) and, if possible, an ozone depletion substance content (ODS) of zero. The fluids' viscosity should be as low as possible. The composition of the mixtures should be advantageously chosen to get azeotropic mixtures. Mixtures of zeotropic nature are also suitable.

It was found that the above-mentioned compounds or their mixtures meet these requirements and therefore constitute suitable working fluids.

The components and preferably the electronic components can be cooled by a direct contact cooling method. In another embodiment the heat pipe can be arranged directly on the component to be cooled or enclose the component.

The following examples are merely intended to explain the invention but the latter shall not be limited to them.

### EXAMPLES 1 TO 3

The cooling system used by us comprised an evaporator and a condensation module. Both modules are connected via a riser pipe or a flexible hose. The system is hermetically closed. The heat transfer fluid circulates in the system.

As an evaporator module, a metal box of copper was used which was filled with each working fluid. The components to be cooled were mounted to the rear of module. The evaporator module itself was mounted to a heating plate the power of which was increased in steps up to 950 Watt. The condenser used to condense the vapour of the working fluid was connected to the riser pipe led out of the evaporator box.

Working Fluid/Examples 1 to 3:
1. HFC 365mfc/Galden HT 55 (65:35)
2. HFC 365mfc
3. Galden HT 55

The results given in the table show the efficiency of the working fluids used according to the invention.

It should be mentioned as a particular advantage of the working fluids of invention that, especially, the mixtures containing HFC 365mfc are inflammable, electrically insulating and environmentally compatible. The azeotropic nature of such mixtures can be considered an additional advantage.

TABLE

| | T_{Component} | | |
|---|---|---|---|
| | [° C.] | T_{Component} | T_{Component} |
| Power Q | R365mfc/Galden | [° C.] | [° C.] |
| [W] | HT55 | R365mfc | Galden HT55 |
| 60 | 34 | 35 | 55.5 |
| 100 | 36 | 37 | 59 |
| 200 | 38.5 | 40 | 60 |
| 300 | 41 | 42 | 63.5 |
| 400 | 44 | 44.5 | 65 |
| 500 | 46 | 47 | 67 |
| 600 | 49 | 50 | 70 |
| 700 | 52 | 53 | 73 |
| 800 | 55 | 55 | 76.5 |
| 900 | 57.5 | 57.5 | 100 |

1-9. (canceled)

10. A working fluid for heat transfer comprising partially fluorinated hydrocarbons, perfluorinated hydrocarbons, mixtures of partially fluorinated hydrocarbons and polyethers, mixtures of perfluorinated hydrocarbons and polyethers, partially fluorinated polyethers, perfluorinated polyethers, or mixtures thereof.

11. The working fluid of claim 10, wherein said partially fluorinated or perfluorinated hydrocarbons comprise one or more pentafluoropropanes, one or more hexafluoropropanes, one or more heptafluoropropanes, one or more pentafluorobutanes, one or more hexafluorobutanes, one or more heptafluorobutanes, one or more decafluoropentanes, or mixtures thereof.

12. The working fluid of claim 11, wherein said partially fluorinated or perfluorinated hydrocarbons are selected from the group consisting of 1,1,1,3,3-pentafluoropropane; 1,1,1,2,3-pentafluoropropane; 1,1,2,2,3-pentafluoropropane; 1,1,1,3,3,3-hexafluoropropane; 1,1,2,3,3,3-hexafluoropropane; 1,1,2,2,3,3-hexafluoropropane; 1,1,1,2,3,3,3-heptafluoropropane; 1,1,1,3,3-pentafluorobutane; 1,1,1,2,2,4-hexafluorobutane; 1,1,1,2,2,4,4-heptafluorobutane; 1,1,1,2,3,4,4,5,5,5-decafluoropentane; and mixtures thereof.

13. The working fluid of claim 10, wherein said working fluid comprises perfluorinated polyethers having at least two C—O—C ether bonds, a molecular weight of approximately 200, and a boiling point above 40° C. at 101.3 kPa.

14. The working fluid of claim 10, wherein said working fluid comprises 1,1,1,3,3-pentafluorobutane and a perfluorinated polyether having a molecular weight of 340.

15. The working fluid of claim 14, wherein the mixing ratio of said 1,1,1,3,3-pentafluorobutane to said perfluorinated polyether is 65:35.

16. A process for cooling a component comprising the step of directly contacting said component with a heat pipe containing a working fluid comprising partially fluorinated hydrocarbons, perfluorinated hydrocarbons, mixtures of partially fluorinated hydrocarbons and polyethers, mixtures of perfluorinated hydrocarbons and polyethers, partially fluorinated polyethers, perfluorinated polyethers, or mixtures thereof.

17. The process of claim 16, wherein said component is electronic.

18. The process of claim 16, wherein said partially fluorinated or perfluorinated hydrocarbons comprises one or more pentafluoropropanes, one or more hexafluoropropanes, one or more heptafluoropropanes, one or more pentafluorobutanes, one or more hexafluorobutanes, one or more heptafluorobutanes, one or more decafluoropentanes, or mixtures thereof.

19. The process of claim 18, wherein said partially fluorinated or perfluorinated hydrocarbons are selected from the group consisting of 1,1,1,3,3-pentafluoropropane; 1,1,1,2,3-pentafluoropropane; 1,1,2,2,3-pentafluoropropane; 1,1,1,3,3,3-hexafluoropropane; 1,1,2,3,3,3-hexafluoropropane; 1,1,2,2,3,3-hexafluoropropane; 1,1,1,2,3,3,3-heptafluoropropane; 1,1,1,3,3-pentafluorobutane; 1,1,1,2,2,4-hexafluorobutane; 1,1,1,2,2,4,4-heptafluorobutane; 1,1,1,2,3,4,4,5,5,5-decafluoropentane; and mixtures thereof.

20. The process of claim 16, wherein said working fluid comprises perfluorinated polyethers having at least two C—O—C ether bonds, a molecular weight of approximately 200, and a boiling point above 40° C. at 101.3 kPa.

21. The process of claim 16, wherein said working fluid comprises 1,1,1,3,3-pentafluorobutane and a perfluorinated polyether having a molecular weight of 340 in a mixing ratio of 65:35.
